(19) United States
(12) Patent Application Publication
(10) Pub. No.: US 2011/0000077 A1
(43) Pub. Date: Jan. 6, 2011

(54) Method and apparatus for machining motor vehicle components

(76) Inventors: Stefan Hilgenberg, Schlangen (DE); Bernhard Bloms, Stavern (DE); Leonhard Meier, Borchen (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/828,837

(22) Filed: Jul. 1, 2010

(30) Foreign Application Priority Data
Jul. 3, 2009 (DE) 10 2009 031 821.6

(51) Int. Cl. B23P 23/04; B23P 17/00

(52) U.S. Cl. 29/592; 29/284

(57) ABSTRACT

An apparatus and related method for making motor vehicle component assemblies of the type having a plurality of previously formed and interconnected elements. A machining tool is supported on an outer end of a pivotable robot arm. A workpiece fixture selectively supports the motor vehicle component assembly, and is pivotal about at least one axis to accurately, yet movably position the motor vehicle component assembly relative to the machining tool for machining portions of the same.

### CLAIM OF PRIORITY

Applicants hereby claim the priority benefits under the provisions of 35 U.S.C. §119, basing said claim of priority on German Patent Application Serial No. 10 2009 031 821.6, filed Jul. 3, 2009. In accordance with the provisions of 35 U.S.C. §119 and Rule 55(b), a certified copy of the above-listed German patent application will be filed before grant of a patent.

### BACKGROUND OF THE INVENTION

The invention relates to an apparatus and to a method for machining components for motor vehicles.

Machining individual components prior to assembling them to create an assembly belongs to the prior art. Apparatus for this type of machining are described for instance in DE 42 42 874 C1 and DE 37 38 619 C2. This method is time and cost-intensive because each component must be clamped or fixture and machined separately.

### SUMMARY OF THE INVENTION

One object of the present invention is to provide a more efficient method and a corresponding apparatus for making motor vehicle components.

The solution to the apparatus portion of the object is an apparatus having the features in patent claim 1.

The solution to the method portion of the object is a method having the features of patent claim 6.

The present apparatus for machining a component for a motor vehicle includes at least one robot arm having a machining tool and a workpiece fixing device or fixture. The component is an assembly produced from a plurality of individual elements that are interconnected in a preceding joining process. Each component element is preferably a sheet metal part that has its geometry created from forming and/or cutting processes, such as stamping or the like. It may have sharp edges. The entire pre-fabricated assembly can be moved and pivoted relative to the robot arm by a pivotable workpiece fixture or tool fixing device. Because of this, the machining tool arranged on the free end of the robot arm reaches all edges of the component assembly. A force-dependent path control can be provided on the tool and/or component assembly to compensate for deviations along the edges of the assembly. After a component assembly has been machined, the tool fixing device and/or the robot arm moves the component assembly and the tool relative to one another, so that the next element of the assembly can be machined by the tool. Multiple clampings or fixturings of individual elements are thus not necessary, and machining time is shortened.

Moreover, it is possible for the workpiece fixture or fixing device to pivot the assembly about a plurality of axes, and also to displace it in a plurality of directions, so that the machining tool can be positioned against all of the locations on the elements of the assembly that are to be machined. To this end, the workpiece fixing device may have multi-axis guides. For pivoting the component assembly, the workpiece fixing device may be provided with at least one rotational axis. The component assembly may be at least tilted about this rotational axis.

The robot arm is program-controlled and may travel along different contours, depending on the geometry of the individual elements and the component assembly. It may also machine the component assembly at different angles.

The component elements are preferably joined together to create a component assembly using a material bond joining method, such as welding or soldering.

The corresponding method for machining a component for a motor vehicle provides that the component is made of a plurality of individual component elements that are joined together prior to machining. The joined component assembly is positioned relative to a machining tool using a pivotable workpiece fixture or fixing device by means of supporting the tool on a robot arm. The individual component elements are joined to one another to create a component assembly prior to the machining, preferably by using a material bond method, especially welding. During machining, the component assembly is fixed in a pivotable workpiece fixture or fixing device, so that the component assembly can be moved relative to the machining tool during the machining process.

The advantage of the present method is that joined component assemblies, for instance instrument panel assemblies, are assembled before the edges of the individual component elements are machined. Consequently, it is not necessary to clamp the individual component elements for the assembly prior to the joining process. The advantages according to the present invention are particularly effective when many individual component elements must be trimmed separately, for instance by debarring or vibratory grinding, before they are joined together to create a larger assembly.

With regard to the present invention, the method applies in particular to instrument panel assemblies. An instrument panel assembly is an elongated support profile that is provided with a plurality of consoles and attachments for supporting and holding additional assemblies in the area of the instrument panel assembly. A large number of lines and cables run in and through the instrument panel assembly area. This is why it is necessary to break, that is, to deburr, trim, and round the edges, preferably the edges of the entire instrument panel assembly, but especially the edges for the instrument attachments. This can be done in a cost-effective manner with the present invention.

These and other advantages of the invention will be further understood and appreciated by those skilled in the art by reference to the following written specification, claims, and appended drawings.

The present invention shall be described in greater detail in the following using exemplary embodiments depicted schematically in the drawings.

### BRIEF DESCRIPTION OF THE DRAWINGS

FIG. 1 is a schematic depiction of a robot arm with a tool for machining an assembly fixed in a pivotable fixing unit; and,

FIGS. 2-2c depict a component and edge contours that can be attained.

### DETAILED DESCRIPTION OF THE PREFERRED EMBODIMENTS

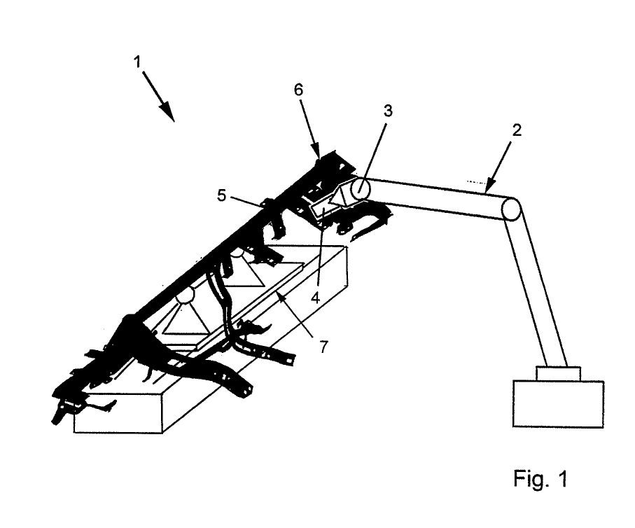

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 1 is a schematic depiction of an apparatus 1 embodying the present invention, having a robot arm 2. A machining tool 4 with a pressure sensor (not shown in greater detail) is arranged on the freely movable end 3 of the robot arm 2. The component assembly 5 to be machined is an element of an assembly 6 joined together from a plurality of individual component elements. In the drawing, the component assembly 6 is an assembled instrument panel assembly. The component assembly 5 is fixed in a workpiece fixture or fixing device 7 that can be pivoted with respect to the robot arm 2. The workpiece fixing device 7 moves the component assembly 6 relative to the machining tool 4, so that the tool can machine all of the relevant elements in the assembly.

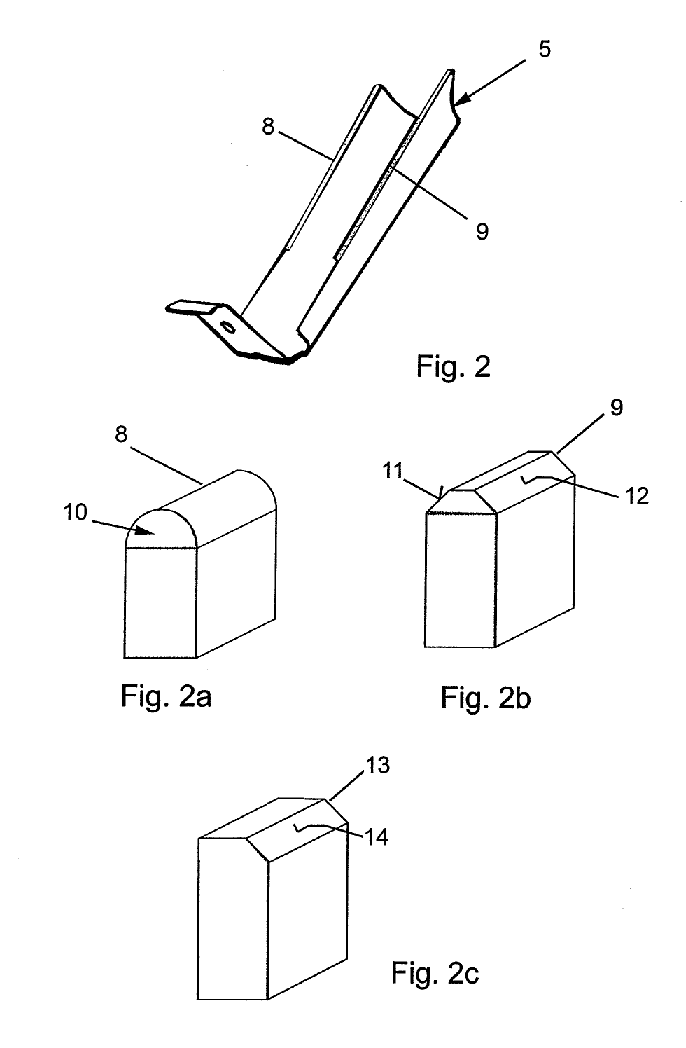

FIG. 2 depicts an element 5 of the component assembly 6. FIG. 2 also provides an enlargement of a section of its edges 8, 9. The edge 8 on the left in the plane of the drawing (FIG. 2a) was machined using the apparatus 1, such that it has a semicircular shape or section 10. The lateral surfaces 11, 12 of the edge 9 on the right in the plane of the drawing (FIG. 2b) were beveled using the apparatus 1. However, it is also possible to trim an edge 13 on only one lateral surface 14 (FIG. 2c). The machining protects cables and lines that must not be abraded on the edges of the instrument panel.

In the foregoing description, it will be readily appreciated by those skilled in the art that modifications may be made to the invention without departing from the concepts disclosed herein. Such modifications are to be considered as included in the following claims, unless these claims by their language expressly state otherwise.

### LEGEND

1—Apparatus
2—Robot arm
3—Free end of 2
4—Tool
5—Component
6—Assembly
7—Workpiece fixing device
8—Edge
9—Edge
10—Section
11—Lateral surface
12—Lateral surface
13—Edge
14—Lateral surface

1-10. (canceled)

11. An apparatus for machining a motor vehicle component assembly of the type having a plurality of previously formed and interconnected elements, comprising:
a pivotable robot arm;
a machining tool supported on said robot arm adjacent an outer end thereof; and
a workpiece fixture selectively supporting the motor vehicle component assembly thereon for machining, and being pivotable about at least one axis to accurately yet movably position the motor vehicle component assembly relative to the machining tool for machining portions of said motor vehicle component assembly.

12. An apparatus as set forth in claim 1, wherein:
the elements of the motor vehicle component assembly are interconnected by material bonds.

13. An apparatus as set forth in claim 1, wherein:
the motor vehicle component assembly comprises an instrument panel assembly.

14. An apparatus as set forth in claim 1, including:
a programmable controller operatively connected with said robot arm and controlling movement of said robot arm.

15. An apparatus as set forth in claim 1, wherein:
at least one of said robot arm and said workpiece fixture has a force-dependent path control.

16. A method for making a motor vehicle component assembly, comprising:
forming a plurality of motor vehicle elements;
rigidly interconnecting the formed motor vehicle elements to define a motor vehicle component assembly;
providing a machining tool;
providing a robot arm;
mounting the machining tool on the robot arm adjacent an outer end thereof;
fabricating a pivotable workpiece fixture shaped to selectively support thereon the motor vehicle component assembly;
detachably mounting the motor vehicle component assembly on the pivotable workpiece fixture;
selectively rotating the motor vehicle component assembly on the pivotable workpiece fixture about at least one axis; and
during said rotating step, machining portions of the motor vehicle component assembly.

17. A method as set forth in claim 16, wherein:
said interconnecting step comprises rigidly bonding the motor vehicle elements together.

18. A method as set forth in claim 16, wherein:
said machining step comprises deburring, trimming, and/or rounding edge portions of the motor vehicle component assembly with the machining tool.

19. A method as set forth in claim 16, wherein:
said machining step comprises deburring, trimming, and/or rounding substantially all edge portions of the motor vehicle component assembly with the machining tool.

20. A method as set forth in claim 16, wherein:
the motor vehicle component assembly comprises an instrument panel assembly.
